(19) United States
(12) Patent Application Publication
(10) Pub. No.: US 2026/0135213 A1
(43) Pub. Date: May 14, 2026

(54) BUTTON BATTERY AND METHOD OF ASSEMBLING THE SAME

(71) Applicant: Eve Energy Co., Ltd., Huizhou (CN)

(72) Inventors: Hong ZHANG, Huizhou (CN); Lixing ZHANG, Huizhou (CN); Peiling SUN, Huizhou (CN); Lang CAO, Huizhou (CN)

(73) Assignee: Eve Energy Co., Ltd., Huizhou (CN)

(21) Appl. No.: 19/023,898

(22) Filed: Jan. 16, 2025

(30) Foreign Application Priority Data
Jun. 25, 2024 (CN) 202410832430.3
Jun. 25, 2024 (CN) 202421470730.3
Sep. 30, 2024 (WO) PCT/CN2024/123024

(51) Int. Cl. H01M 50/184; H01M 50/109; H01M 50/186; H01M 50/533; H01M 50/559; H01M 50/566

(52) U.S. Cl. CPC H01M 50/184; H01M 50/109; H01M 50/186; H01M 50/533; H01M 50/559; H01M 50/566

(57) ABSTRACT

A button battery and a method of assembling the button battery are provided by the present disclosure. The button battery includes a positive electrode cap assembly, a positive electrode current collector, and a positive plate. The positive electrode cap assembly includes a positive electrode cap and a gasket. The gasket includes a gasket part and an elastic plate part intersected with each other. At least one of the elastic plate part and the gasket part is provided with a protruding structure. The protruding structure passes through the through hole and is fixed to the positive plate.

### RELATED APPLICATIONS

The application claims the benefit of priority, under the Paris Convention, of International Application No. PCT/CN2024/123024 filed on Sep. 30, 2024, Chinese Patent Application No. 202410832430.3 filed on Jun. 25, 2024, and Chinese Patent Application No. 202421470730.3 filed on Jun. 25, 2024. The disclosures of the abovementioned applications are incorporated herein by reference in their entireties.

### FIELD AND BACKGROUND OF THE INVENTION

The present disclosure relates to afield of battery technologies, and in particular, to a button battery and a method of assembling the button battery.

As an energy source, a stable power supply is a basic requirement for button batteries. High internal resistance of the button batteries may lead to reduced battery life, decreased capacity, increased self-discharge rate, reduced voltage, and battery heating. Therefore, the internal resistance of the button batteries is generally used as one of important indicators to evaluate reliability and stability of the button batteries. That is, an initial internal resistance of the button batteries is required to be less than 10Ω, and the internal resistance should be less than 20Ω after being stored for one week at 85° C.

With the development of society and changes in market, application environments for the button batteries have become increasingly harsh. For example, the button batteries are required to supply stable power under high temperature, high humidity, high voltage, high-frequency vibration, and high-speed centrifugation conditions. That is, the internal resistance of the button batteries is less than 15Ω after being stored for 100 hours at 125° C.

As the storage temperature for the button batteries increases from 85° C. to 125° C., a bulging degree of a positive electrode cap is increased due to a structure of a positive electrode current collector and an assembly process between the positive electrode current collector and the positive electrode cap in related art. A gap between the positive electrode current collector and the positive electrode cap is increased, resulting in poor contact therebetween and a decrease in a current collection efficiency of the positive electrode current collector. The batteries are unable to provide stable power, thereby failing to meet requirements of current application scenarios for the button batteries.

### SUMMARY OF THE INVENTION

In a first aspect, a button battery is provided by the present disclosure. The button battery includes a positive electrode cap assembly, a positive electrode current collector, and a positive plate.

The positive electrode cap assembly includes a positive electrode cap and a gasket mounted inside the positive electrode cap.

The positive electrode current collector is disposed inside the positive electrode cap and provided with an accommodation cavity. A bottom wall of the positive electrode current collector is provided with a through hole.

The positive plate is disposed inside the accommodation cavity.

The gasket includes a gasket part and an elastic plate part intersected with each other. A length of the gasket part is provided as L1, and a length of the elastic plate part is provided as L2, where L1>L2. At least one of the elastic plate part and the gasket part is provided with a protruding structure. The protruding structure passes through the through hole and is fixed to the positive plate.

In a second aspect, a method of assembling the button battery mentioned above is provided by the present disclosure. The method includes:
adjusting a relative position between the gasket and the positive electrode cap, and welding the gasket and the positive electrode cap together to form a positive electrode cap assembly;
placing the positive plate into the positive electrode current collector to form a positive electrode assembly;
placing a negative plate into a negative electrode cap to form a negative electrode assembly;
sequentially placing a separator and the positive electrode assembly into the negative electrode assembly to form an assembly;
injecting an electrolyte into the assembly; and
covering the positive electrode cap assembly on an end of the assembly.

### BRIEF DESCRIPTION OF THE DRAWINGS

FIG. 1 is a cross-sectional structural view at one angle of a button battery according to some embodiments of the present disclosure.

FIG. 2 is a cross-sectional structural view at another angle of the button battery according to some embodiments of the present disclosure.

FIG. 3 is a cross-sectional structural view at one angle of the button battery according to other embodiments of the present disclosure.

FIG. 4 is a three-dimensional view of a gasket according to some embodiments of the present disclosure.

FIG. 5a is a view of a material band for a gasket assembly according to some embodiments of the present disclosure.

FIG. 5b is a view of a material band for a gasket assembly according to other embodiments of the present disclosure.

FIG. 6 is a cross-sectional structural view at one angle of an elastic plate according to some embodiments of the present disclosure.

FIG. 7a is a partial enlarged view of FIG. 6 according to some embodiments of the present disclosure.

FIG. 7b is a partial enlarged view of FIG. 6 according to other embodiments of the present disclosure.

FIG. 8 is a cross-sectional structural view at another angle of the gasket according to some embodiments of the present disclosure.

FIG. 9a is a first three-dimensional view of the gasket according to some embodiments of the present disclosure.

FIG. 9b is a second three-dimensional view of the gasket according to some embodiments of the present disclosure.

FIG. 9c is a third three-dimensional view of the gasket according to some embodiments of the present disclosure.

FIG. 9d is a fourth three-dimensional view of the gasket according to some embodiments of the present disclosure.

FIG. 10 is a three-dimensional view of the gasket according to some embodiments of the present disclosure and a positive electrode cap welded together.

FIG. 11 is a cross-sectional view of the gasket according to some embodiments of the present disclosure and the positive electrode cap welded together.

FIG. 12 is a front view of the gasket and the positive electrode cap welded together according to some embodiments of the present disclosure.

FIG. 13 is a view showing positions of welding points between the gasket according to some embodiments of the present disclosure and the positive electrode cap.

FIG. 14 is a schematic view at one angle showing positions of the gasket according to some embodiments of the present disclosure and a positive electrode current collector.

FIG. 15a is a schematic view of construction lines of the gasket according to some embodiments of the present disclosure.

FIG. 15b is a schematic view of the construction lines of the gasket provided by other embodiments of the present disclosure.

FIG. 16 is a schematic position view at another angle of the gasket according to some embodiments of the present disclosure and the positive electrode current collector.

FIG. 17 is a cross-sectional view of the gasket according to some embodiments of the present disclosure and the positive electrode current collector.

FIG. 18a is a view showing positions of the gasket according to some comparative examples of the present disclosure and the positive electrode current collector.

FIG. 18b is a view showing positions of the gasket according to other comparative examples of the present disclosure and the positive electrode current collector.

FIG. 19 is a schematic dimensional view of the gasket according to some embodiments of the present disclosure.

FIG. 20a is a cross-sectional view of the gasket according to Embodiment 1 of the present disclosure.

FIG. 20b is a cross-sectional view of the gasket according to Comparative Example 1 of the present disclosure.

FIG. 20c is a cross-sectional view of the gasket according to Comparative Example 2 of the present disclosure.

### REFERENCE NUMERALS

1, button battery; 11, positive electrode cap; 111, boss structure; 12, negative electrode cap; 13, sealing ring; 14, positive electrode current collector; 141, annular bottom wall; 142, through hole; 143, side wall; 144, accommodation cavity; 15, positive plate; 16, negative plate; 17, separator; 19, electrolyte; 20, gasket; 21, gasket part; 211, gasket base body; 212, gasket boss; 214, gasket end part; 2141, first gasket end part; 2142, second gasket end part; 2143, gasket end point; 215, gasket side edge; 22, elastic plate part; 222, elastic plate end part; 2223, elastic plate end point; 23, protruding structure; 231, first flange; 232, second flange; 233, protrusion; 23a, exceeded region; 23b, not-exceeded region; 24, base surface; 25, positioning hole; 210, first welding point; 241, second welding point; 242, third welding point; 220, positive electrode cap assembly; Q1, first region; Q2a, first part of second region; Q2b, second part of second region; Q3a, first part of third region; Q3b, second part of third region; 200, gasket assembly.

### DESCRIPTION OF SPECIFIC EMBODIMENTS OF THE INVENTION

In the present disclosure, unless otherwise specified, directional terms used, such as “up” and “down”, generally refer to upper and lower directions of the device in its actual usage or operational state, specifically as depicted in the accompanying drawings. However, “inside”, and “outside” are in reference to the outline of the device.

A button battery is mainly composed of a positive electrode cap, a negative electrode cap, a sealing ring, a positive electrode current collector, a positive plate, a negative electrode active material, a separator, and an electrolyte. In related art, considering cost of battery assembly processes, generally after the positive plate is placed inside the positive electrode current collector, the positive electrode current collector is placed inside the positive electrode cap, and then the positive electrode cap is in close contact with the positive electrode current collector by sealing and pressing.

Since the positive electrode current collector is directly placed inside the positive electrode cap, there is no limit structure between the positive electrode current collector and the positive electrode cap, resulting in easy movement of the positive electrode current collector inside the button battery. Especially, under violent vibration and high-speed centrifugation conditions, the positive electrode current collector is seriously deviated, resulting in poor contact among internal components. The button battery is prone to occur problems such as current fluctuations, low voltage, low capacity, and high resistance. Moreover, when the button battery is stored at a high temperature, the positive electrode cap may bulge, and a gap is defined between the positive electrode current collector and the positive electrode cap. This leads to poor contact among internal parts, resulting in low voltage, poor discharge, and high internal resistance of the button battery.

As an energy source, a stable power supply is a basic requirement for the button batteries. High internal resistance of the button battery may lead to reduced battery life, decreased capacity, increased self-discharge rate, reduced voltage, and battery heating. Therefore, the internal resistance of the button battery is generally used as one of important indicators to evaluate the reliability and stability of the button battery. That is, an initial internal resistance of the button battery is required to be less than 10Ω, and the internal resistance should be less than 20Ω after being stored for one week at 85° C.

With the development of society and changes in market, application environments for the button battery have become increasingly harsh. For example, the button battery is required to supply stable power under high temperature, high humidity, high voltage, high-frequency vibration, and the high-speed centrifugation conditions. That is, the internal resistance of the button battery is less than 15Ω after being stored for 100 hours at 125° C.

As the storage temperature for the button battery increases from 85° C. to 125° C., a bulging degree of a positive electrode cap is increased due to a structure of a positive electrode current collector and an assembly process between the positive electrode current collector and the positive electrode cap in related art. A gap between the positive electrode current collector and the positive electrode cap is increased, resulting in poor contact therebetween and a decrease in a current collection efficiency of the positive electrode current collector. The battery is unable to provide stable power, thereby failing to meet requirements of current application scenarios for the button battery.

In order to improve the stability of the electrical performance of the button battery in extreme environments, the internal structure of the button battery of the present disclosure is optimized to improve the current collecting effect.

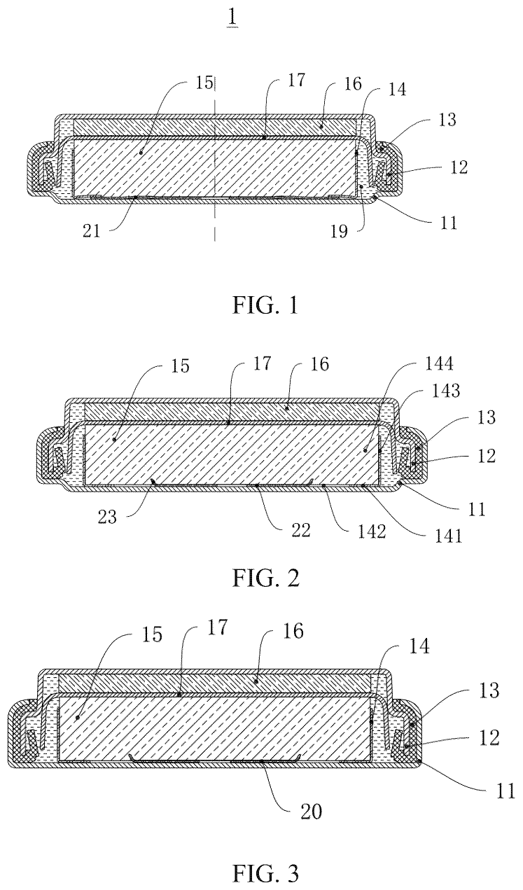

Referring to FIG. 1 to FIG. 3, a button battery 1 is provided by the present disclosure. The button battery 1 includes a positive electrode cap 11, a negative electrode cap 12, a sealing ring 13, a positive electrode current collector 14, a positive plate 15, a negative plate 16, a separator 17, and an electrolyte 19.

The positive electrode cap 11 is provided as an open cap-shaped structure. As shown in FIG. 3, an outer side surface of the positive electrode cap 11 may be constructed as an upright surface. As shown in FIG. 1, the outer side surface of the positive electrode cap 11 may be provided with a boss structure 111.

The negative electrode cap 12 is provided as an open cap-shaped structure. Both an inner diameter and an outer diameter of the positive electrode cap 11 are greater than an inner diameter and an outer diameter of the negative electrode cap 12, so that the positive electrode cap 11 can be capped over outside of the negative electrode cap 12.

The sealing ring 13 is disposed on a connection position between the positive electrode cap 11 and the negative electrode cap 12. The sealing ring 13 forms a wrapping structure for at least a part of an outer side wall of the negative electrode cap 12, so that a sealing connection structure is formed between the positive electrode cap 11 and the negative electrode cap 12. Moreover, the sealing ring 13 is further used to provide insulation between the positive electrode cap 11 and the negative electrode cap 12.

The positive electrode current collector 14 is accommodated in an inner cavity of the positive electrode cap 11. The positive electrode current collector 14 may be any one of a current collecting ring, a current collecting mesh, and a current collecting sheet. As shown in FIG. 1, the positive electrode current collector 14 is provided as a current collecting ring. The positive electrode current collector 14 includes an annular bottom wall 141 and a side wall 143 circumferentially connected onto the annular bottom wall 141. The annular bottom wall 141 and the side wall 143 enclose an accommodation cavity 144. The annular bottom wall 141 is provided with a through hole 142. An inner diameter of the positive electrode current collector 14 is less than the inner diameter of the negative electrode cap 12.

The positive plate 15 is accommodated inside the accommodation cavity 144 of the positive electrode current collector 14 and is in contact with the positive electrode cap 11 through the through hole 142.

The negative plate 16 is accommodated inside the inner cavity of the negative electrode cap 12.

The separator 17 is disposed between the positive plate 15 and the negative plate 16 for separating the positive plate 15 and the negative plate 16. A projection surface of the negative plate 16 on the separator 17 substantially coincides with a projection surface of the positive plate 15 on the separator 17.

The electrolyte 19 is filled inside the entire button battery 1. After the electrolyte 19 is injected, internal structures such as the negative plate 16 and the positive plate 15 are in a state of being immersed in the electrolyte 19, and charged ions in the positive plate 15 and the negative plate 16 are electrically communicated through the electrolyte 19.

Continuing to refer to FIG. 1 to FIG. 3, the button battery 1 further includes a gasket 20. The gasket 20 is connected to an inner surface of the positive electrode cap 11. The gasket 20 includes a gasket part 21 and an elastic plate part 22 intersected with each other. A length L1 of the gasket part 21 is greater than a length L2 of the elastic plate part 22. Two ends of the gasket part 21 are connected to the positive electrode current collector 14. The elastic plate part 22 is located inside the positive electrode current collector 14. At least one of the elastic plate part 22 and the gasket part 21 is provided with a protruding structure 23 used for fixing the positive plate 15.

The gasket 20 is added into the button battery 1. The gasket 20 is connected to the positive electrode cap 11. The length L1 of the gasket part 21 of the gasket 20 is greater than the length L2 of the elastic plate part 22. The two ends of the gasket part 21 are connected to the positive electrode current collector 14. The elastic plate part 22 is located inside the positive electrode current collector 14. At least one of the elastic plate part 22 and the gasket part 21 is further provided with the protruding structure 23 used for further fixing the positive plate 15. The gasket 20 is configured to be respectively connected to the positive electrode cap 11 and the positive electrode current collector 14. The protruding structure 23 on the gasket 20 is used for further fixing the positive plate 15. Thus the positive electrode cap 11 remains in contact with the positive electrode cap 11 and the positive electrode current collector 14 when the positive electrode cap 11 bulges, thereby improving the stability of the internal structures of the battery.

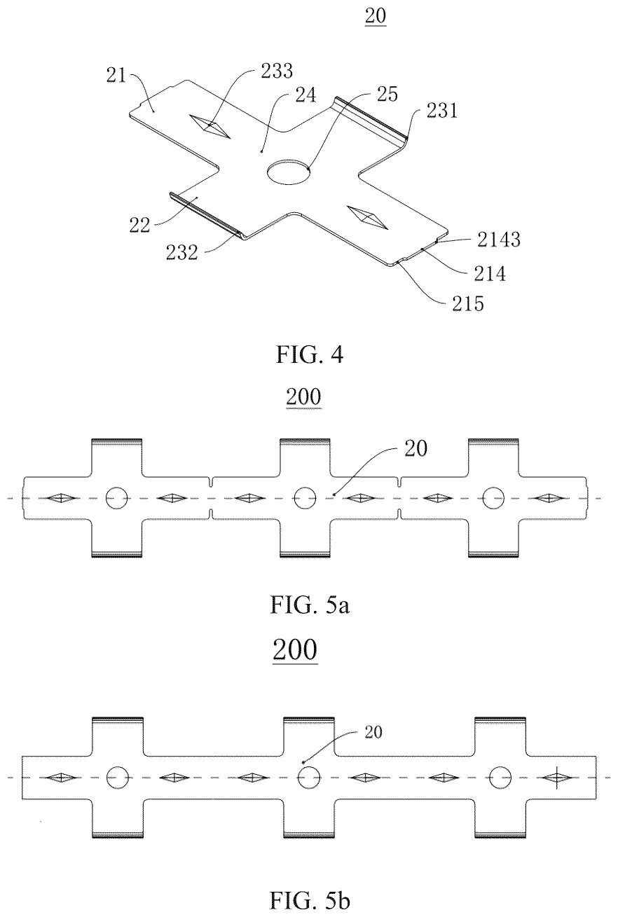

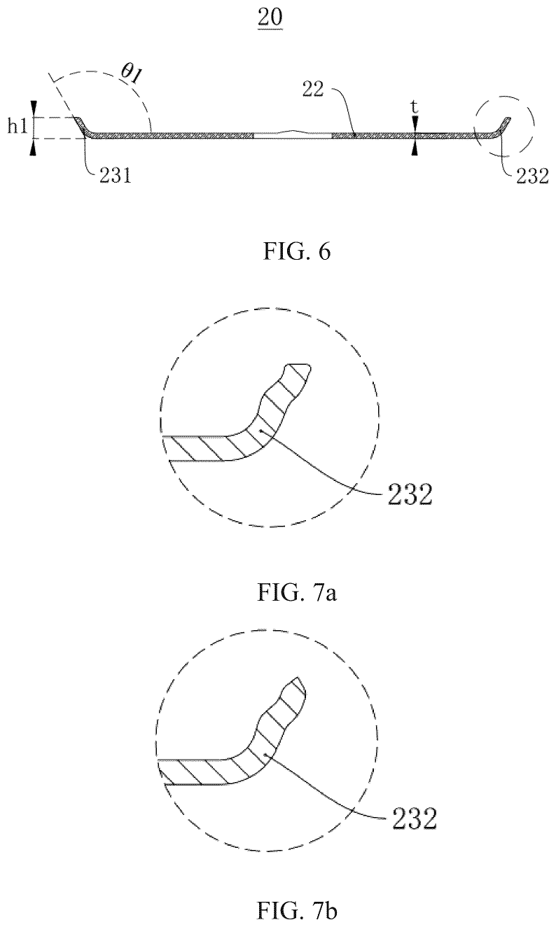

Continuing to refer to FIG. 4 and FIG. 6, the gasket part 21 and the elastic plate part 22 of the gasket 20 and the protruding structure 23 are integrally formed. A thickness of the gasket 20 is provided as t, where 0.05 mm [symbol] t [symbol] 0.30 mm.

A material of the gasket 20 may be any one of SUS44, SUS304, SUS430, SUS316, and SUS444. In some specific embodiments, the gasket 20 is made of the SUS430, so that the gasket 20 itself is magnetic. This is conducive to reducing the welding difficulty between the gasket 20 and the positive electrode cap 11 or the positive electrode current collector 14, thereby improving the feasibility of welding.

The thickness t of the gasket 20 ranges from 0.05 mm to 0.30 mm. In some embodiments, the thickness t of the gasket 20 ranges from 0.10 mm to 0.20 mm. In some specific embodiments, the thickness t of the gasket 20 may be 0.05 mm, 0.10 mm, 0.15 mm, 0.20 mm, 0.25 mm, 0.30 mm, a value between any two of the above-mentioned values, or a range between any two of the above-mentioned values. Through research, Inventors have found that when the thickness t of the gasket 20 is less than 0.05 mm, a strength of the gasket 20 is low and the gasket 20 deforms easily, so that an elastic connection function of the gasket 20 cannot be exerted. When the thickness t of the gasket 20 is greater than 0.30 mm, a volume of the gasket 20 increases and occupies internal space of the battery, resulting in a decrease in a capacity of the battery.

As shown in FIG. 5a and FIG. 5b, a method of manufacturing a gasket is provided by the present disclosure. The gasket is processed and molded by a stamping forming process. During a stamping process, a gasket assembly 200 is formed by a plurality of gaskets 20 rolled with connecting material edges in form of a roll. Continuing to refer to FIG. 5a, the plurality of gaskets 20 are connected by the connecting material edges. Adjacent two of the gaskets 20 are cut to form two single gaskets 20, and a side edge of each of the two single gaskets 20 is still provided with a protruding end structure. Continuing to refer to FIG. 5b, the plurality of gaskets 20 are directly connected. Adjacent two of the gaskets 20 are cut to form the two single gaskets 20 with the side edges thereof being flush.

Continuing to refer to FIG. 4, the protruding structure 23 disposed on the gasket 20 and used for fixing the positive plate 15 includes a first flange 231 and a second flange 232. The first flange 231 and the second flange 232 are located at two ends of the elastic plate part 22, respectively.

In the present disclosure, the first flange 231 and the second flange 232 are disposed at the two ends of the elastic plate part 22, respectively. The first flange 231 and the second flange 232 can be embedded in the positive plate 15. Compared the protruding structure 23 disposed at other positions of the elastic plate part 22, the protruding structure 23 disposed at the two ends of the elastic plate part 22 can bring enlarged contact area between the gasket 20 and the positive plate 15, thereby improving a limiting effect between the protruding structure 23 and the positive plate 15. In particular, when the button battery 1 is subjected to extreme vibration and centrifugation conditions, the position movement of the positive electrode current collector 14 and the gasket 20 inside the battery can be reduced by the first flange 231 and the second flange 232. Mutual impact forces among the positive plate 15, and the negative plate 16 of the battery and the electrolyte are reduced, thereby further reducing the internal resistance of the battery and improving the stability of battery performance.

As shown in FIG. 6, a height of the first flange 231 or the second flange 232 in a thickness direction of the button battery 1 is provided as h1, where 2*t [symbol] h1 [symbol] 10*t. An included angle defined by an extension line of an outer tangent plane of the first flange 231 or the second flange 232 and a plane where the elastic plate part 22 is located ranges from 900 to 150°.

In some embodiments, the first flange 231 and the second flange 232 are arranged symmetrically about a center of the gasket 20. A height of the first flange 231 protruding with respect to a base surface 24 of the elastic plate part 22 is the same as a height of the second flange 232 protruding with respect to a base surface 24 of the elastic plate part 22, and both are set as h1. In some embodiments, the h1 may be 2*t, 3*t, 4*t, 5*t, 6*t, 7*t, 8*t, 9*t, 10*t, a value between any two of the above-mentioned values, or a range between any two of the above-mentioned values. Through research, the Inventors have found that when the height h1 of the first flange 231 or the second flange 232 satisfies: 2*t [symbol] h1 [symbol] 10*t, after the first flange 231 and the second flange 232 are embedded in the positive plate 15, an overall structure of the positive plate 15 will not be damaged by the first flange 231 or the second flange 232, resulting in chip decay or powder loss. Moreover, the first flange 231 and the second flange 232 do not deforms during a process of being embedded in the positive plate 15. Specifically, when the height h1 of the first flange 231 or the second flange 232 is less than 2*t, since a depth of the first flange 231 or the second flange 232 being embedded in the positive plate 15 is not large enough, the first flange 231 or the second flange 232 is prone to be separated from the positive plate 15 when the positive electrode cap 11 bulges outward, resulting in poor contact between the gasket 20 as a whole and the positive electrode current collector 14. When the height h1 of the first flange 231 or the second flange 232 is greater than 10*t, the first flange 231 and the second flange 232 need to be embedded in the positive plate 15 at a relatively large depth. During the process of the first flange 231 and the second flange 232 being embedded in the positive plate 15, the gasket 20 is prone to deform and the overall structure of the positive plate 15 is prone to be damaged.

Continuing to refer to FIG. 6, the included angle defined by the extension line of the outer tangent plane of the first flange 231 or the second flange 232 and the lane where the elastic plate part 22 is located is provided as θ1, where 90° [symbol] θ1 [symbol] 150°.

In some specific embodiments, the first flange 231 or the second flange 232 are arranged symmetrically about the center of the gasket 20. The included angle defined by the extension line of the outer tangent plane of the first flange 231 and the plane where the elastic plate part 22 is located is the same as the included angle defined by the extension line of the outer tangent plane of the second flange 232 and the plane where the elastic plate part 22 is located, and both are set to θ1. The θ1 needs to satisfy: 90° [symbol] θ1 [symbol] 150°. For example, the θ1 may be 90°, 100°, 110°, 120°, 130°, 140°, 150°, an angle between any two of the above-mentioned angles, or a range between any two of the above-mentioned angles. Through research, the Inventors have found that when the θ1 is less than 90°, the first flange 231 or the second flange 232 are difficult to be embedded in the positive plate 15. When the θ1 is greater than 150°, a range of the first flange 231 or the second flange 232 being embedded in the positive plate 15 is too large, and the overall structure of the positive plate 15 is prone to be damaged, resulting in powder loss falling off of the positive plate 15.

The first flange 231 or the second flange 232 may be provided as a straight-edged inclined structure. As shown in FIG. 7a, the first flange 231 or the second flange 232 may also be provided in a wave-shaped inclined structure. As shown in FIG. 7b, the first flange 231 or the second flange 232 may also be provided as an inclined structure having a sharp angle structure at an end part.

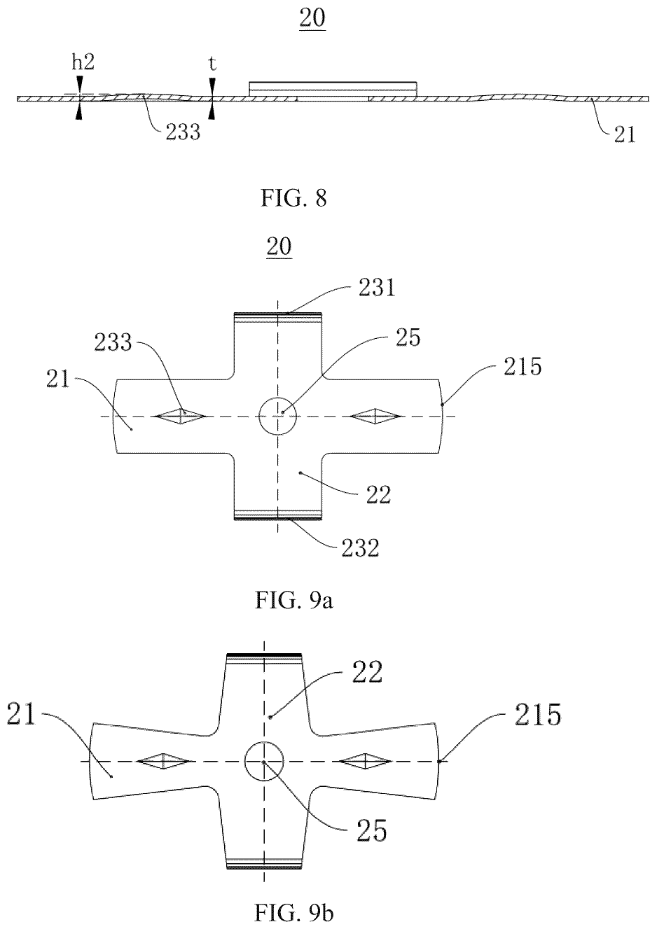

Continuing to refer to FIG. 4 and FIG. 8, the protruding structure 23 includes at least two protrusions 233 arranged on the gasket part 21. The at least two protrusions 233 are symmetrically arranged at two sides of the elastic plate part 22.

In the present disclosure, the at least two protrusions 233 are arranged on the gasket part 21 and are further embedded in the positive plate 15, so that the contact area between the gasket 20 and the positive plate 15 is increased, thereby increasing the limiting effect of the protruding structure 23 on the positive plate 15. When the button battery 1 is in the extreme vibration or centrifugation conditions, the protruding structure 23 mentioned-above can effectively prevent the positive electrode current collector 14 and the gasket 20 from being relatively displaced inside the button battery 1, so that the mutual impact forces among the positive plate 15, and the negative plate 16 and the electrolyte 19 are reduced, thereby further reducing the internal resistance of the button battery 1 and improving the stability of electrical performance of the button battery 1.

Two protrusions 233 are arranged on the gasket part 21. The two protrusions 233 are symmetrically arranged with respect to the elastic plate part 22. The first flange 231 and the second flange 232 are arranged at the two ends of the elastic plate part 22, respectively. The first flange 231 and the second flange 232 are symmetrically arranged with respect to the gasket part 21. Since the gasket part 21 and the elastic plate part 22 are intersected with each other, the two protrusions 233 can be configured to provide a fixing force in a first direction to the positive plate 15. The first flange 231 and the second flange 232 can be configured to provide a fixing force in a second direction to the positive plate 15. As such, the positive plate 15 is simultaneously subjected to the fixing force in the first direction and the fixed force in the second direction provided by the gasket 20, so that the gasket 20 can sufficiently limit the displacement of the positive plate 15 relative to the gasket 20 in extreme environments.

As shown in FIG. 8, a height of each of the at least two protrusions 233 along a thickness direction of the button battery 1 is provided as h2, where 1.5*t [symbol] h2 [symbol] 3*t.

In some specific embodiments, the height h2 of each of the two projections 233 protruding with respect to the plane where the gasket part 21 is located may be 1.5*t, 2.0*t, 2.5*t, 3.0*t, a value between any two of the above-mentioned values, or a range between any two of the above-mentioned values. Through research, the Inventors have found that when the height h2 of each of the protrusions 233 is less than 1.5*t, since a depth of the two protrusions 233 embedded in the positive plate 15 is not large enough, the two protrusions 233 are prone to be separated from the positive plate 15 when the positive electrode cap 11 bulges outward, resulting in poor contact between the gasket 20 as a whole and the positive electrode current collector 14. When the height h2 of each of the two protrusions 233 is greater than 3*t, the two protrusions 233 need to be embedded in the positive plate 15 at a relatively large depth. This causes that the process of embedding the two protrusions 233 is difficult, and the overall structure of the positive plate 15 is prone to be damaged, resulting in powder dropping.

An overall shape of each of the two protrusions 233 may be a triangular triangular pyramidal or a polyprismatic structure having a sharp angle structure.

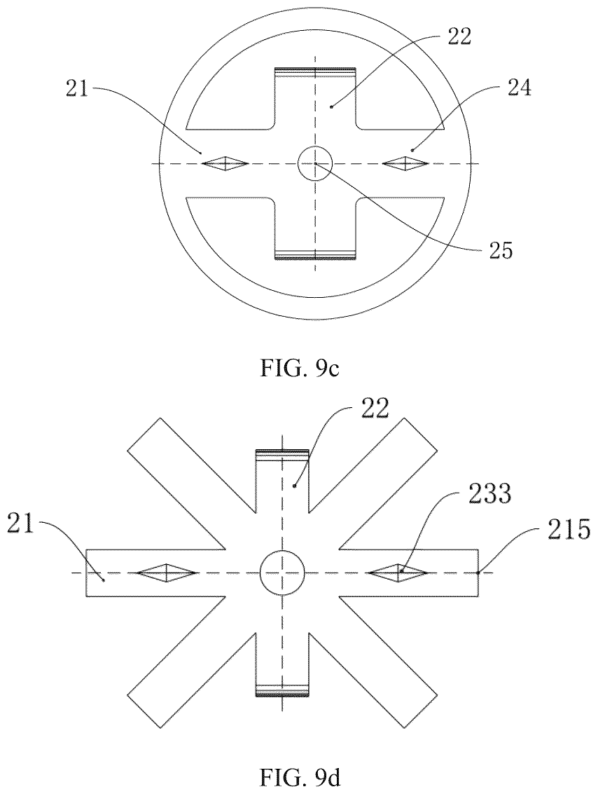

Continuing to refer to FIG. 4 and FIG. 9a to FIG. 9d, an orthographic projection of the gasket 20 on the positive electrode cap 11 is in the shape of a cross, of a [symbol] , or of a combination of a circle and a cross.

The base surface 24 of the gasket 20 may be a cross-shaped structure. The gasket part 21 and the elastic plate part 22 are intersected with each other to form an intersection part. The gasket part 21 includes a first part of the gasket part 21 and a second part of the gasket part 21 symmetrically arranged with respect to the intersection part. The elastic plate part 22 includes a first part of the elastic plate part 22 and a second part of the elastic plate part 22 symmetrically arranged with respect to the intersection part.

In some specific embodiments, as shown in FIG. 4, the base surface 24 of the gasket 20 may be provided as a cross-shaped structure. Each of the two parts of the gasket part 21 and each of the two parts of the elastic plate part 22 are provided as a regular rectangular structure, respectively. In other alternative embodiments, the base surface 24 of the gasket 20 may be provided as an irregular cross-shaped structure. As shown in FIG. 9a, both side edges of the two parts of the gasket part 21 are provided as an arc-shaped structure, respectively. As shown in FIG. 9b, the base surface 24 of the gasket part 21 is provided as the irregular cross-shaped structure. Specifically, the two parts of the gasket part 21 are provided as a fan-shaped structure, and the two parts of the elastic plate part 22 are also provided as a fan-shaped structure. As shown in FIG. 9c, the base surface 24 of the gasket 20 includes an outer ring part and an inner joint part. The outer ring part is constructed as a closed circular ring structure. The inner joint part is constructed as a cross-shaped structure. The two ends of the gasket part 21 are connected on an annular edge. Continuing to refer to FIG. 9d, the base surface 24 of the gasket 20 is provided as the “ [symbol] ”-shaped structure or other polygonal structure. An outer periphery of the base surface 24 connected to the intersection part is provided with a plurality of extension parts, that is, a third extension part, a fourth extension part, or a fifth extension part between the gasket part 21 and the elastic plate part 22. Among them, the length L1 of the gasket part 21 is greater than the length L2 of the elastic plate part 22, a length of the third extension part, and a length of the fourth extension part, respectively.

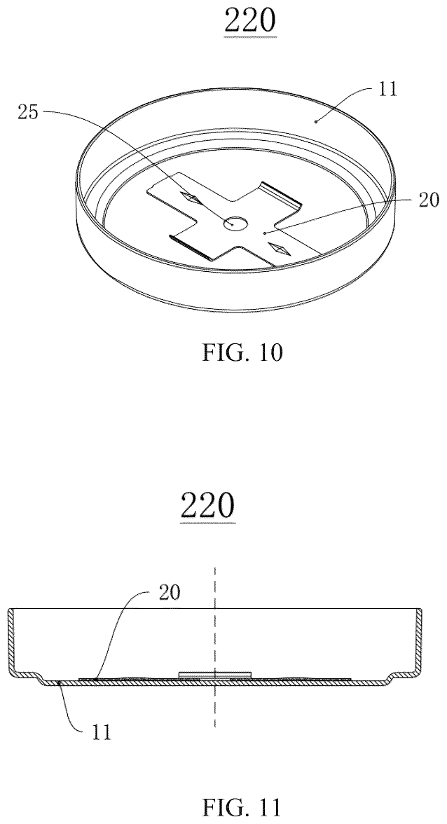

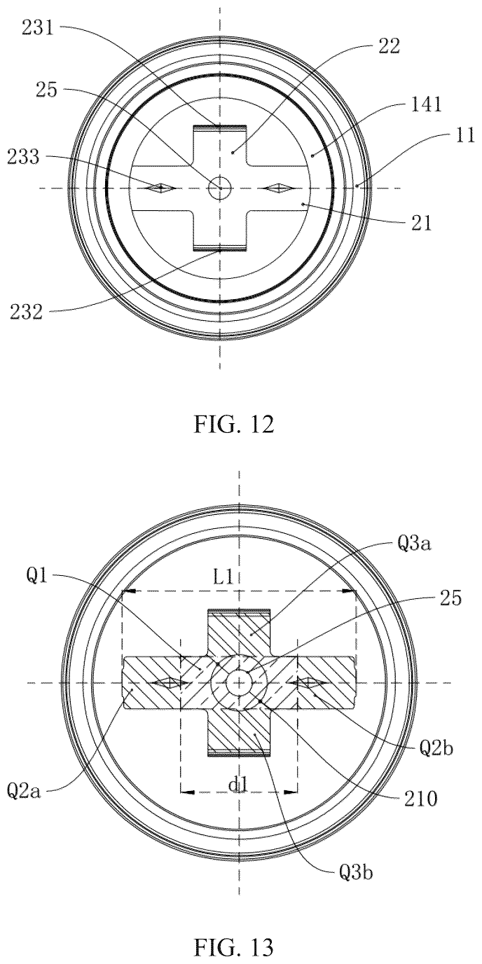

Continuing to refer to FIG. 10 to FIG. 12, the gasket 20 is provided with a positioning hole 25 configured for providing positioning when welding the gasket 20 to the positive electrode cap 11. The gasket 20 is welded to the inner surface of the positive electrode cap 11. A concentricity between the gasket 20 and the positive electrode cap 11 is less than or equal to 0.3 mm.

The gasket 20 is connected to the inner surface of the positive electrode cap 11 by welding. The center of the gasket 20 is provided with the positioning hole 25. An intersection region between the gasket part 21 and the elastic plate part 22 is located at the center of the gasket 20. The positioning hole 25 is located at a center of the intersection region between the gasket part 21 and the elastic plate part 22.

The gasket assembly 200 in form of a roll shown in FIG. 5a and FIG. 5b is transferred into a laser welding equipment and is cut into a plurality of single gaskets 20. At the same time, the positive electrode cap 11 is placed in a fixture by using a vibrating disc feeding method. During a process of welding the gasket 20 and the positive electrode cap 11, the gasket 20 is placed on the inner surface of the positive electrode cap 11 by clamping the positioning hole 25 using the fixture. The gasket 20 and the positive electrode cap 11 are centrally positioned through the positioning hole 25. The gasket 20 and the positive electrode cap 11 are welded together by laser welding.

During an assembling process, the concentricity between the gasket 20 and the positive electrode cap 11 needs to be controlled to be less than or equal to 0.3 mm. In some embodiments, the concentricity between the gasket 20 and the positive electrode cap 11 is less than or equal to 0.1 mm. Through research, the Inventors have found that if the concentricity between the positive electrode cap 11 and the gasket 20 is greater than 0.3 mm, deviation between the gasket 20 and the positive electrode cap 11 will be serious, and thereby deviation between the gasket 20 and the positive electrode current collector 14 will be serious, thereby reducing a current collecting effect of the positive electrode current collector 14, and further affecting the electrical performance of the button battery 1.

As shown in FIG. 13, at least two first welding points 210 are provided between the gasket 20 and the positive electrode cap 11. At least two of the first welding points 210 are symmetrically arranged with respect to a center point of the gasket 20.

Through research, the Inventors have found that during the process of welding the gasket 20 and the positive electrode cap 11, a number of the first welding points 210 formed by welding the gasket 20 and the positive electrode cap 11 is two. Two first welding points 210 contribute to improving a welding strength between the gasket 20 and the positive electrode cap 11. If the number of the first welding points 210 formed between the gasket 20 and the positive electrode cap 11 by welding is one, the gasket 20 is prone to be deviated and warped with respect to the positive electrode cap 11. If the number of the first welding points 210 formed between the gasket 20 and the positive electrode cap 11 by welding is more than two, the welding process between the gasket 20 and the positive electrode cap 11 is complicated, and the welding cost is further increased.

Continuing to refer to FIG. 13, a position of a welding region between the gasket 20 and the positive electrode cap 11 is optimized to further improve the stability performance of the button battery 1.

The base surface 24 of the gasket 20 configured to be welded is divided into five regions, i.e., a first region Q1, a first part of a second region Q2a, a second part of the second region Q2b, a first part of a third region Q3a, and a second part of the third region Q3b. The first region Q1 is located at the intersection region between the gasket part 21 and the elastic plate part 22. The first part of the second region Q2a and the second part of the second region Q2b are arranged at two sides of the first region Q1 and located on the gasket part 21. The first part of the third region Q3a and the second part of the third region Q3b are arranged at other two sides of the first region Q1 and located on the elastic plate part 22. The length of the gasket part 21 is provided as L1. A length of the first region Q1 extending along the gasket part 21 is provided as d1, where d1=0.5*L1. A width of the first region Q1 extending along the elastic plate part 22 is equal to a width of the gasket part 21.

The first welding points 210 between the gasket 20 and the positive electrode cap 11 may be disposed in the first region Q1 or the first part of the second region Q2a and the second part of the second region Q2b. In some specific embodiments, the first welding points 210 between the gasket 20 and the positive electrode cap 11 are disposed in the first part of the second region Q2a and the second part of the second region Q2b. The first welding points 210 between the gasket 20 and the positive electrode cap 11 are disposed outside the first part of the third region Q3a and the second part of the third region Q3b. Through research, the Inventors have found that if the first welding points 210 between the gasket 20 and the positive electrode cap 11 are located in the first part of the third region Q3a and the second part of the third region Q3b, the first part of the third region Q3a and the second part of the third region Q3b where the gasket 20 is located will lose elasticity. When the positive electrode cap 11 bulges, since the region where the first flange 231 and the second flange 232 are located on the gasket 20 is welded on the positive electrode cap 11, the first flange 231 and the second flange 232 are separated from the positive electrode cap 15. This causes poor contact between the gasket 20 and the positive electrode cap 15, resulting in failure of the limiting effect of the first flange 231 and the second flange 232 on the positive electrode plate 15.

A method of assembling the button battery is further provided by the present disclosure. The method incudes following steps.

The positive electrode cap 11 and the gasket 20 are welded together to form a positive electrode cap assembly 220.

The positive plate 15 is pressed into the inner cavity of the positive electrode current collector 14 to form a collar positive electrode;

The negative plate 16 is placed into the inner cavity of the negative electrode cap 12. The separator 17 and the collar positive electrode are placed in sequence. The sealing ring 13 is wrapped on an outer surface of the negative electrode cap 12. After the electrolyte 19 is injected, the positive electrode cap assembly 220 is closed and sealed to form the button battery 1. After assembling is completed, the button battery 1 is pre-discharged and aged.

The gasket 20 is welded to the inner surface of the positive electrode cap 11. The positive electrode current collector 14 is placed on the gasket 20. The positive electrode current collector 14 and the gasket 20 are not completely concentric. That is, there is a positional deviation between the center of the positive electrode current collector 14 and the center of the gasket 20.

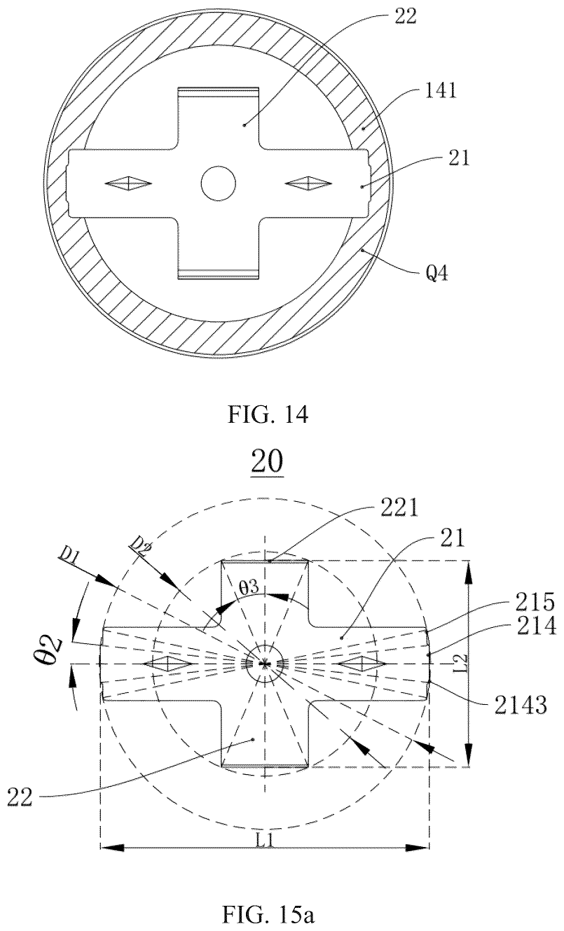

As shown in FIG. 14 to FIG. 17, the positive electrode current collector 14 includes the annular bottom wall 141. The annular bottom wall 141 is provided with the through hole 142. The two ends of the gasket part 21 are connected to the annular bottom wall 141.

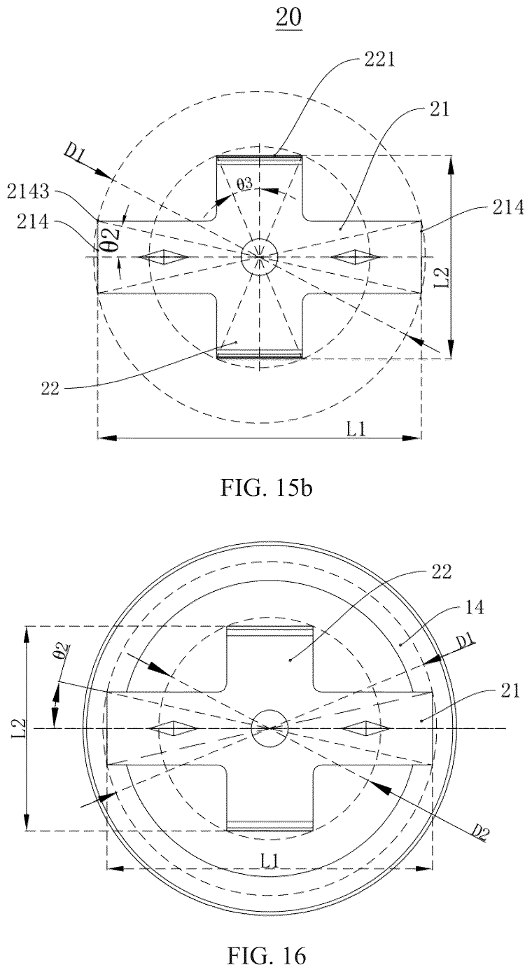

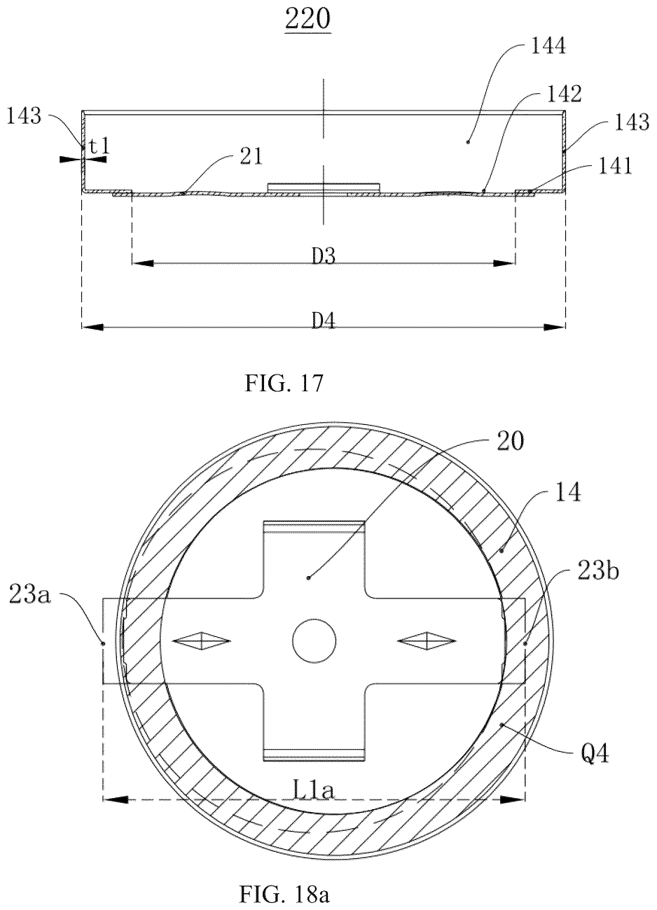

As shown in FIG. 15a, FIG. 15b, FIG. 16, and FIG. 17, a diameter of a circumscribed circle corresponding to an edge of the gasket part 21 is provided as D1. A diameter of a circumscribed circle corresponding to an edge of the elastic plate part 22 is provided as D2. A diameter of the through hole 142 of the positive electrode current collector 14 is provided as D3. A diameter of the annular bottom wall 141 of the positive electrode current collector 14 is provided as D4. A thickness of the positive electrode current collector 14 is provided as t1. The gasket part 21 includes two gasket end parts 214. One of the two gasket end parts 214 includes two gasket end points 2143. An included angle between two connecting lines between the two gasket end points 2143 and the center point of the gasket 20 is 2*θ2.

Continuing to refer to FIG. 15a, in some embodiments, the gasket part 21 includes two gasket side edges 215. Each of the two gasket side edges 215 is provided with one protruding gasket end part 214. The side edge where the gasket end part 214 is located includes two gasket end points 2143. An included angle between two connecting lines between the two gasket end points 2143 and the center point of the gasket 20 is 2*θ2.

Continuing to refer to FIG. 15b, in other embodiments, the gasket part 21 includes two gasket side edges 215 provided as straight edges. Each of the gasket end parts 214 is constructed by a corresponding one of the two gasket side edges 215. Each of the gasket end parts 214 includes two gasket end points 2143. An included angle between two connecting lines between the two gasket end points 2143 and the center point of the gasket 20 is 2*θ2.

In order to ensure that the two ends of the gasket part 21 of the gasket 20 are always in contact with the annular bottom wall 141 of the positive electrode current collector 14, (i.e., the two ends of the gasket part 21 are always located in a region Q3 where the annular bottom wall 141 of the positive electrode current collector 14 is located), and meanwhile that the two ends of the gasket part 21 are always overlapped in the region Q3 where the annular bottom wall 141 of the positive electrode current collector 14 is located after the battery is sealed, the Inventors have found through research that the length L1 of the gasket part 21 satisfies: L1=D1*cosθ2, and 1.02*D3*cosθ2 [symbol] L1 [symbol] 0.98*(D4-2*t1)*cosθ2, i.e., 1.02*D3*cosθ2 [symbol] L1 [symbol] 0.98*(D4-2t1)*cosθ2.

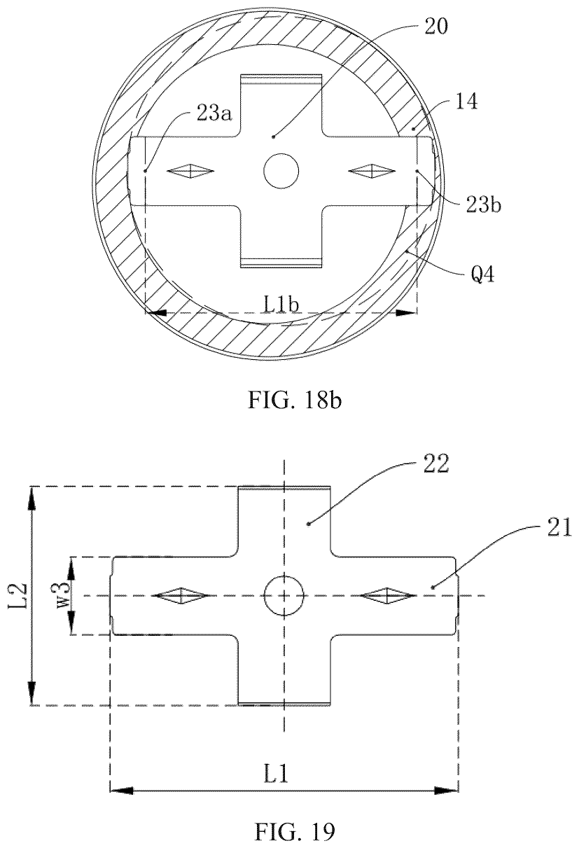

Continuing to refer to FIG. 18a, if the length of the gasket part 21 is provided as L1a, where L1a>0.98*(D4-2t1)*cosθ2, at least a part of a region where one of the flanges of the gasket 20 is located exceeds an edge of the positive electrode current collector 14, such as an exceeded region 23a shown in FIG. 18a. A region where the other one of the flanges of the gasket 20 is located does not exceed the edge of the positive electrode current collector 14, such as a non-exceeded region 23b shown in FIG. 18a. During a process of sealing the button battery 1, since an edge strength of the positive electrode current collector 14 is greater than a strength of the plane where the bottom wall of the positive electrode current collector 14 is located, a height of the gasket 20 corresponding to the exceeded region 23a exceeding the edge of the positive electrode current collector 14 is greater than a height of the gasket 20 corresponding to the non-exceeded region 23b not exceeding the edge of the positive electrode current collector 14. This causes a difference between high and low levels inside the positive electrode current collector 14, thereby reducing the current collecting effect of the positive electrode current collector 14.

Continuing to refer to FIG. 18b, if the length of the gasket part 21 is provided as L1b, where L1b<1.02*D3*cosθ2, a region where one of the flanges of the gasket 20 is located is disposed in a region where the through hole 142 of the positive electrode current collector 14 is located, such as an exceeded region 23a shown in FIG. 18b. A region where the other one of flanges of the gasket 20 is located is disposed a plane region where the bottom wall of the positive electrode current collector 14 is located, such as a non-exceeded region 23b shown in FIG. 18a. During the process of sealing the button battery 1, since a height of the gasket 20 corresponding to the exceeded region 23a where one of the flanges of the gasket 20 is located at the through hole 142 of the positive electrode current collector 14 is greater than a height of the gasket 20 corresponding to the non-exceeded region 23b where the other one of the flanges of the gasket 20 is located at the plane where the bottom wall of the positive electrode current collector 14 is located. This causes the difference between high and low levels inside the positive electrode current collector 14, thereby reducing the current collecting effect of the positive electrode current collector 14.

Continuing to refer to FIG. 15a, FIG. 15b, FIG. 17, and FIG. 19, the length of the gasket part 21 is provided as L1. The length of the elastic plate part 22 is provided as L2. A width of the gasket part 21 extending along an extending direction of the elastic plate part 22 is provided as w3. The elastic plate part 22 includes two elastic plate end parts 222. Each of the two elastic plate end parts 222 includes two elastic plate end points 2223. An included angle between two connecting lines between the two elastic plate end points 2223 and the center point of the gasket 20 is 2*θ3. The diameter of the through hole 142 of the positive electrode current collector 14 is provided as D3.

The first flange 231 and the second flange 232 of the gasket 20 are provided as the inclined structure with a certain inclination angle. When the button battery 1 is sealed, the first flange 231 and the second flange 232 are embedded inside the positive plate 15 to limit the positive plate 15. In order to ensure that the first flange 231 and the second flange 232 of the gasket 20 can always be embedded inside the positive plate 15 to be elastically connected to the positive plate 15 when there is the positional deviation between gasket 20 and positive electrode current collector 14 or the positive electrode cap 11 bulges outward, the Inventors have found through research that the length L2 of the elastic plate part 22 satisfies: 1.5*w3 [symbol] L2 [symbol] 0.98*D3*cosθ3.

If the length L2 of the elastic plate part 22 is greater than 0.98*D3*cosθ3, the relative positional deviation between the gasket 20 and the positive electrode current collector 14 is too large, and any one or both of the first flange 231 and the second flange 232 cannot be embedded into the positive plate 15. If the length L2 of the elastic plate part 22 is less than 1.5*w3, when the positive electrode cap 11 bulges outward, any one or both of the first flange 231 and the second flange 232 of the gasket 20 move outward along with the positive electrode cap 11. This causes that any one or both of the first flange 231 and the second flange 232 are separated from the positive plate 15, resulting in failure of an elastic limiting effect of the gasket 20 on the positive electrode current collector 14 and a poor contact between the gasket 20 and the positive electrode current collector 14.

In the present disclosure, Embodiment 1, Comparative Example 1, and Comparative Example 2 are further provided. Variations of internal resistances of batteries of Embodiment 1, Comparative Example 1, and Comparative Example 2 in a high temperature environment are further verified by performing a high temperature storage experiment on the button batteries 1 provided by Embodiment 1, Comparative Example 1, and Comparative Example 2.

### EMBODIMENT 1

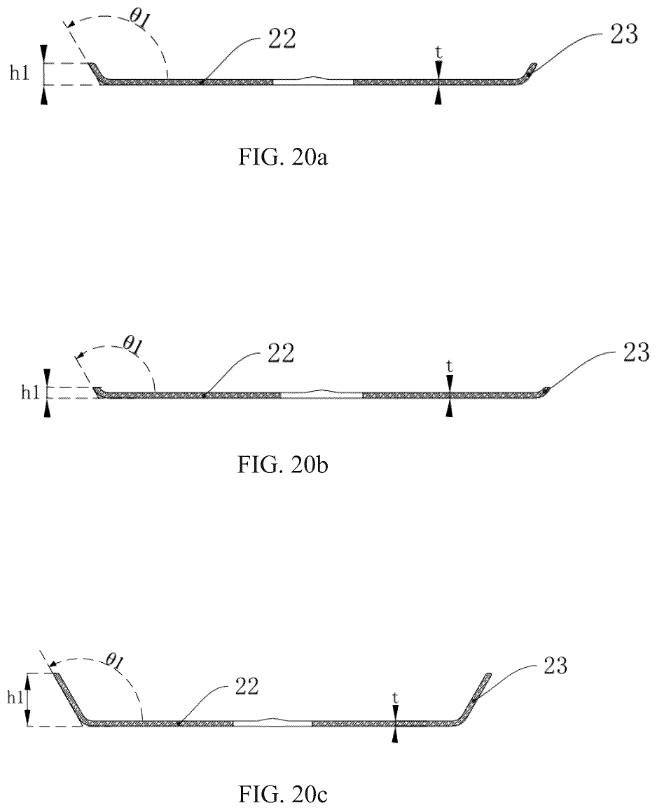

The button battery 1 provided by Embodiment 1 includes a gasket 20. A cross-sectional structure of the gasket 20 is shown in FIG. 20a. A base surface 24 of the gasket 20 adopts a centrally circumferentially symmetrical cross structure, where L1=0.91*(D4-2*t1)*cosθ2, L2=0.72*D3*cosθ3, t=0.10, θ1=120°, and H1=4*t.

### COMPARATIVE EXAMPLE 1

The button battery 1 provided by Comparative Example 1 includes a gasket 20. A cross-sectional structure of the gasket 20 is shown in FIG. 20b. A base surface 24 of the gasket 20 adopts a centrally circumferentially symmetrical cross structure, where L1=0.91*(D4-2*t1)*cosθ2, L2=0.72*D3*cosθ3, t=0.10, θ1=120°, and H1=10*t.

### COMPARATIVE EXAMPLE 2

The button battery 1 provided by Comparative Example 2 includes a gasket 20. A cross-sectional structure of the gasket 20 is shown in FIG. 20c. A base surface 24 of the gasket 20 adopts a centrally circumferentially symmetrical cross structure, where L1=0.91*(D4-2*t1)*cosθ2, L2=0.72*D3*cosθ3, t=0.10, θ1=120°, and H1=2*t.

(High temperature storage experiment: internal resistance evaluation) For the button batteries of Embodiment 1, Comparative Example 1, and Comparative Example 2 obtained in the above order are performed to the high temperature storage experiment as described below is preformed, whereby the changes of the internal resistances under a high temperature environment are evaluated.

Specifically, first, the internal resistances (Ω) between the positive electrode and the negative electrode of each of the button batteries obtained in Embodiment 1, Comparative Example 1, and Comparative Example 2 are measured in a same method, and the initial resistances (Ω) are shown in Table 1 below. Next, the button batteries of Embodiment 1, Comparative Example 1, and Comparative Example 2 are stored in a high-temperature chamber with an internal temperature of 125° C. for one week. After one week of storage, the internal resistances (Ω) between the positive electrode and the negative electrode of the button batteries of Embodiment 1, Comparative Example 1, and Comparative Example 2 are measured using the same method. The values are used as the internal resistances (Ω) after one week of storage and are shown in Table 1 below.

TABLE 1

| | | Internal internal resistance (Ω) | | Increase |
|---|---|---|---|---|
| | | | After one | rate of |
| | Height of | | week of | internal |
| Project | flange | Initial | storage | resistance |
| Embodiment 1 | 4*t | 3.461 | 6.671 | 93% |
| Comparative | 10*t | 13.370 | 22.934 | 72% |
| Example 1 | | | | |
| Comparative | 2*t | 3.451 | 14.423 | 318% |
| Example 2 | | | | |

### Evaluation Results:

As shown in Table 1, comparing Embodiment 1 (the height of the flange is 4*t, and the initial internal resistance is 3.461Ω) with Comparative Example 1 (the height of the flange is 10*t, and the initial internal resistance is 13.370Ω), the initial internal resistance of the button battery of Embodiment 1 has obvious advantages. After disassembling and analyzing of the batteries, the initial internal resistance of Comparative Example 1 is much higher than the initial internal resistance of Embodiment 1. The reason is that after the flange of the gasket 20 are embedded in the positive plate 15, the flange of the gasket 20 deforms and the positive plate 15 drops powder, resulting in poor internal contact, which leads to the initial internal resistance being much higher than that of Embodiment 1.

Comparing Embodiment 1 (the height of the flange is 4*t) with Comparative Example 2 (the height of the flange is 2*t), the initial internal resistances of the button batteries are not much different. However, after the button batteries are stored at 125° C. for one week, an internal resistance increase rate of the button battery provided by Comparative Example 2 is much higher than an internal resistance increase rate of the button battery provided by Embodiment 1. After CT image analysis of the button batteries, it is found that the flange of the gasket 20 of the button battery provided by Comparative Example 2 are separated from the positive plate 15, resulting in poor internal contact of the battery under high temperature storage.

The beneficial effects of the present disclosure are illustrated below. In the button battery provided by the present disclosure, the gasket is added into the button battery. The gasket is connected to the positive electrode cap. The length of the gasket part of the gasket is greater than the length of the elastic plate part of the gasket. Two ends of the gasket part are connected to the positive electrode current collector, respectively. At least one of the elastic plate part and the gasket part is further provided with a protruding structure for further fixing the positive plate. When the positive electrode cap bulges, the positive electrode cap remains in contact with the positive plate inside the positive electrode current collector, thereby improving the stability of internal structures of the battery.

In the method of assembling the button battery provided by the present disclosure, the gasket is welded to the positive electrode cap, and the protruding structure on the gasket is used for further fixing the positive plate, so that when the positive electrode cap bulges, the positive electrode cap remains in contact with the positive plate inside the positive electrode current collector, thereby improving the stability of the internal structures of the battery.

What is claimed is:

1. A button battery, comprising:
a positive electrode cap assembly comprising a positive electrode cap and a gasket mounted inside the positive electrode cap;
a positive electrode current collector disposed inside the positive electrode cap and provided with an accommodation cavity, wherein a bottom wall of the positive electrode current collector is provided with a through hole; and
a positive plate disposed inside the accommodation cavity;
wherein the gasket comprises a gasket part and an elastic plate part intersected with each other, a length of the gasket part is provided as L1, a length of the elastic plate part is provided as L2, where L1>L2, at least one of the elastic plate part and the gasket part is provided with a protruding structure, and the protruding structure passes through the through hole and is fixed to the positive plate.

2. The button battery according to claim 1, wherein the gasket part, the elastic plate part, and the protruding structure are integrally formed, and a thickness of the gasket is provided as t, where 0.05 mm≤t≤0.30 mm.

3. The button battery according to claim 1, wherein the protruding structure comprises a first flange and a second flange arranged at two ends of the elastic plate part, respectively.

4. The button battery according to claim 3, wherein a height of the first flange or the second flange in a thickness direction of the button battery is provided as h1, where 2*t<h1<10*t; or
an included angle defined by an extension line of an outer tangent plane of the first flange or the second flange and by a plane where the elastic plate part is located is provided as θ1, where 90° [symbol] θ1 [symbol] 150°; or
a height of the first flange or the second flange in a thickness direction of the button battery is provided as h1, and an included angle defined by an extension line of an outer tangent plane of the first flange or the second flange and a plane where the elastic plate part is located is provided as θ1, where 2*t<h1<10*t, and 90° [symbol] θ1 [symbol] 150°.

5. The button battery according to claim 4, wherein the first flange or the second flange are arranged symmetrically about a center of the gasket, and the included angle defined by the extension line of the outer tangent plane of the first flange and the plane where the elastic plate part is located is the same as the included angle defined by the extension line of the outer tangent plane of the second flange and the plane where the elastic plate part is located.

6. The button battery according to claim 3, wherein the first flange or the second flange is be provided as any one of a straight-edged inclined structure, a wave-shaped inclined structure, or an inclined structure having a sharp angle structure at an end part.

7. The button battery according to claim 1, wherein the protruding structure comprises at least two protrusions arranged on the gasket part, and the at least two protrusions are symmetrically arranged at both sides of the elastic plate part.

8. The button battery according to claim 7, wherein a height of each of the at least two protrusions along a thickness direction of the button battery is provided as h2, where 1.5*t [symbol] h2 [symbol] 3*t.

9. The button battery according to claim 1, wherein an orthographic projection of the gasket on the positive electrode cap is in the shape of a cross, of a [symbol] , or of a combination shape of a circle and a cross.

10. The button battery according to claim 1, wherein the gasket is provided with a positioning hole configured for providing positioning when welding the gasket to the positive electrode cap, and a concentricity between the gasket and the positive electrode cap is less than or equal to 0.3 mm.

11. The button battery according to claim 10, wherein the concentricity between the gasket and the positive electrode cap is less than or equal to 0.1 mm.

12. The button battery according to claim 10, wherein at least two first welding points are provided between the gasket and the positive electrode cap, and the at least two of the first welding points are symmetrically arranged with respect to a center point of the gasket.

13. The button battery according to claim 12, wherein the gasket comprises:
a first region symmetrically arranged with respect to a centerline of the gasket part and a centerline of the elastic plate part, wherein a length of the first region is provided as d1, where d1=0.5*L1, and a width of the first region is equal to a width of the gasket part;
a second region located on the gasket part, comprising a first part of the second region and a second part of the second region, wherein the first part of the second region and the second part of the second region are located on two sides of the first region, respectively; and
a third region located on the elastic plate part, comprising a first part of the third region and a second part of the third region, wherein the first part of the third region and the second part of the third region are located on two sides of the first region, respectively;
wherein the at least two of the first welding points are located in the first region, or in the first part of the second region and the second part of the second region, and the at least two of the first welding points are located outside the first part of the third region and the second part of the third region.

14. The button battery according to claim 1, wherein the positive electrode current collector comprises an annular bottom wall, and two ends of the gasket part are connected to the annular bottom wall.

15. The button battery according to claim 14, wherein the gasket part comprises two gasket end parts, one of the two gasket end parts comprises two gasket end points, and an included angle between two connecting lines between the two gasket end points and the center point of the gasket is 2*θ2; and
wherein a diameter of a circumscribed circle corresponding to an edge of the gasket part is provided as D1, a diameter of the through hole of the positive electrode current collector is provided as D3, a diameter of the annular bottom wall of the positive electrode current collector is provided as D4, a thickness of the positive electrode current collector is provided as t1, and the length L1 of the gasket part satisfies: L1=D1*cosθ2, and 1.02*D3*cosθ2 [symbol] L1 [symbol] 0.98*(D4-2*t1)*cosθ2.

16. The button battery according to claim 15, wherein the gasket part comprises two gasket side edges arranged oppositely, and each of the gasket end parts protrudes with respect to a corresponding one of the gasket side edges or is flush with the corresponding one of the gasket side edges.

17. The button battery according to claim 15, wherein a width of the gasket part is provided as w3, the elastic plate part comprises two elastic plate end parts, one of the two elastic plate end parts comprises two elastic plate end points, an included angle between two connecting lines between the two elastic plate end points and the center point of the gasket is 2*θ3, and the length L2 of the elastic plate part satisfies: 1.5*w3 [symbol] L2 [symbol] 0.98*D3*cosθ3.

18. A method of assembling the button battery, wherein the button battery comprises:
a positive electrode cap assembly comprising a positive electrode cap and a gasket mounted inside the positive electrode cap;
a positive electrode current collector disposed inside the positive electrode cap and provided with an accommodation cavity, wherein a bottom wall of the positive electrode current collector is provided with a through hole; and
a positive plate disposed inside the accommodation cavity;
wherein the gasket comprises a gasket part and an elastic plate part intersected with each other, a length of the gasket part is provided as L1, a length of the elastic plate part is provided as L2, where L1>L2, at least one of the elastic plate part and the gasket part is provided with a protruding structure, and the protruding structure passes through the through hole and is fixed to the positive plate;
the method comprising:
adjusting a relative position between the gasket and the positive electrode cap, and welding the gasket and the positive electrode cap together to form a positive electrode cap assembly;
placing the positive plate into the positive electrode current collector to form a positive electrode assembly;
placing a negative plate into a negative electrode cap to form a negative electrode assembly;
sequentially placing a separator and the positive electrode assembly into the negative electrode assembly to form an assembly;
injecting an electrolyte into the assembly; and
covering the positive electrode cap assembly on an end of the assembly.

19. The method of assembling the button battery according to claim 18, wherein the gasket part, the elastic plate part, and the protruding structure are integrally formed, and a thickness of the gasket is provided as t, where 0.05 [symbol] mm t [symbol] 0.30 mm.

20. The method of assembling the button battery according to claim 18, wherein the protruding structure comprises a first flange and a second flange arranged at two ends of the elastic plate part, respectively.
